(19) United States
(12) Patent Application Publication
(10) Pub. No.: US 2009/0141278 A1
(43) Pub. Date: Jun. 4, 2009

(54) SYSTEMS AND METHODS FOR DETERMING WHETHER A BIOLOGICAL SPECIMEN CARRIER IS PROPERLY ORIENTED

(75) Inventor: Douglas A. Tenney, North Reading, MA (US)

Correspondence Address: VISTA IP LAW GROUP LLP, 12930 Saratoga Avenue, Suite D-2, Saratoga, CA, 95070, US

(73) Assignee: CYTYC CORPORATION, Marlborough, MA (US)

(21) Appl. No.: 11/947,669

(22) Filed: Nov. 29, 2007

(51) Int. Cl. G01N 21/00

(52) U.S. Cl. 356/432

(57) ABSTRACT

Systems and methods for determining whether a biological specimen carrier, such as a specimen slide, is arranged in its proper orientation. An optically absorptive element is associated with a surface of the biological specimen carrier. Light emitted from a light source is incident on a surface of the carrier. A slide is properly oriented when the incident light is substantially absorbed by the absorptive element. One or more sensors are positioned to detect light that is not absorbed by the absorptive element. An output of a sensor indicates whether the biological specimen slide is properly oriented and may drive indicator directly or through a controller or other system component to indicate whether the slide is properly oriented.

### FIELD OF THE INVENTION

The present inventions relate to systems and methods for confirming orientations of biological specimen carriers.

### BACKGROUND

Automated and semi-automated cytological processing systems use robotic actuators, arms or other devices to move specimen carriers, such as specimen slides, to different processing stations. In one known processing system, a robotic arm or actuator is used to remove a slide from a storage receptacle such as a cassette, process the slide or specimen (e.g., image the specimen), and then return the slide into the cassette. A processing system may also acquire a slide from a storage receptacle and position the slide on a stage. A cytotechnologist may then review the specimen to determine whether the specimen contains cancerous or pre-cancerous cells and to detect various medical conditions.

The orientation of a slide may not be known when a robotic actuator or arm selects the slide for processing. For example, the slide may be properly oriented, e.g., such that the specimen is on a top surface of the slide and a reference mark or identifier is positioned at a desired location. However, there may be some cases, e.g., due to human error, when one or more slides are rotated from their desired position. For example, the slide may be inadvertently rotated by 180 degrees. As a result, the reference mark or identifier on the slide may not be in the correct location, thereby causing errors the processing system attempts to read the reference mark. Further, reference points or locations of selected sections of the specimen identified by a cytotechnologist based on the slide being in its proper orientation may not match the corresponding locations on the slide when the slide is rotated. A slide may also be inadvertently flipped or placed upside down such that the specimen faces a downward direction rather than facing in the intended upward direction for imaging or review. The reference mark or identifier also may not be readable when the slide is oriented upside down. Similar issues must be addressed when a slide is inadvertently rotated and flipped or placed upside down.

### SUMMARY

A system constructed according to one embodiment for determining an orientation of a biological specimen carrier includes an optically absorptive element, a light source and a sensor. The optically absorptive element is associated with a surface of the biological specimen carrier, and the light source is positioned or arranged such that light emitted by the light source is incident on the surface of the biological specimen carrier. A biological specimen carrier is properly oriented when incident light is substantially absorbed by the absorptive element. The sensor is positioned to detect light not absorbed by the absorptive element and reflected by the surface of the biological specimen carrier.

A system constructed according to another embodiment for determining an orientation of a biological specimen carrier includes an optically absorptive element, a light source and two sensors. The optically absorptive element is associated with a surface of the biological specimen carrier. The light source is positioned on a first side of the biological specimen carrier such that light emitted by the light source is incident on the surface of the biological specimen carrier. The biological specimen carrier is properly oriented when incident light is substantially absorbed by the absorptive element. The first sensor is positioned on the first side of the biological specimen carrier to detect light not absorbed by the absorptive element and reflected by the surface of the biological specimen carrier. The second sensor is positioned on a second side of the biological specimen carrier to detect light not absorbed by the absorptive element and transmitted through the biological specimen carrier.

Another embodiment is directed to a method of determining an orientation of a biological specimen carrier. The method includes positioning a light source on a first side of the biological specimen carrier. The light source is positioned or arranged such that light emitted by the light source is incident on a surface of the biological specimen carrier. The biological specimen carrier is properly oriented if incident light is substantially absorbed by the absorptive element. The method further includes positioning a first sensor on the first side of the specimen carrier. The first sensor is positioned to detect light not absorbed by the absorptive element and reflected by the surface of the biological specimen carrier.

In one or more embodiments, an output of the sensor based on a quantity of detected light indicates whether the biological specimen carrier, such as a biological specimen slide, is properly oriented. For example, when the biological specimen carrier is not properly oriented, incident light may be incident upon a portion of the biological specimen carrier other than the optically absorptive element. Embodiments may be used to determine that a biological specimen carrier is rotated, flipped, or rotated and flipped. In such cases, a sensor will detect a sufficient quantity of reflected and/or transmitted light and may be used to drive an indicator, such as a light or speaker, a controller, or other system component.

Further, in one or more embodiments, light from a light source, such as a light emitting diode, is incident on the surface of the biological specimen carrier at an acute angle of incidence relative to the surface of the biological specimen carrier, and may be reflected from the surface at an acute angle of reflection relative to the surface. For example, the angle of incidence may be about 30-60 degrees.

Moreover, in one or more embodiments, the absorptive element is attached to the surface of the biological specimen carrier. In one embodiment, the absorptive element is a label having suitable optical properties. The absorptive element may also be formed within the biological specimen carrier. In one embodiment, the absorptive element is a frosted section of a slide that typically serves as a writing surface or a pen or pencil.

### BRIEF DESCRIPTION OF THE DRAWINGS

Referring now to the drawings in which like reference numbers represent corresponding parts throughout and in which:

FIG. 1A illustrates a system constructed in accordance with one embodiment that is configured to detect whether a biological specimen carrier is arranged in its proper orientation;

FIG. 1B is a top view of a biological specimen slide having sides that are longer than front faces or edges and having a frosted end section;

FIG. 1C is a perspective view of a biological specimen slide having sides that are longer than front faces or edges and having a frosted end section;

FIG. 2A illustrates optical or light indicators driven by a controller that may be used in one embodiment;

FIG. 2B illustrates an audible indicator driven by a controller that may be used in another embodiment;

FIG. 3A illustrates a system constructed in accordance with one embodiment having a single sensor and being configured to determine whether a specimen slide is arranged in its proper orientation;

FIG. 3B is a top view of the slide arranged as shown in FIG. 3A;

FIG. 4A illustrates the system shown in FIG. 3A configured to detect a specimen slide that is improperly rotated;

FIG. 4B is a top view of the slide arranged as shown in FIG. 4A;

FIG. 5A illustrates the system shown in FIG. 3A configured to detect a specimen slide that is improperly rotated and flipped;

FIG. 5B is a top view of the slide arranged as shown in FIG. 5A;

FIG. 6A illustrates the system shown in FIG. 3A configured to detect a specimen slide that is improperly flipped;

FIG. 6B is a top view of the slide arranged as shown in FIG. 6A;

FIG. 7A is a top view of a specimen slide having multiple absorptive elements;

FIG. 7B is a perspective view of the specimen slide arranged as shown in FIG. 7A;

FIG. 8A illustrates the system shown in FIG. 3A configured to determine whether the specimen slide shown in FIGS. 7A-B is improperly flipped based on reflection of incident light;

FIG. 8B is a top view of the slide arranged as shown in FIG. 8A;

FIG. 9A illustrates a multi-sensor system constructed in accordance with one embodiment and configured to determine whether a specimen slide is arranged in its proper orientation based on absorption of incident light;

FIG. 9B is a top view of the slide as arranged as shown in FIG. 9A;

FIG. 10A illustrates the system shown in FIG. 9A configured to detect a specimen slide that is improperly rotated based on reflection of incident light;

FIG. 10B is a top view of the slide as arranged as shown in FIG. 10A;

FIG. 11A illustrates the system shown in FIG. 9A configured to detect a specimen slide that is improperly rotated and flipped based on reflection of incident light;

FIG. 11B is a top view of the slide as arranged as shown in FIG. 11A;

FIG. 12A illustrates the system shown in FIG. 9A configured to detect a specimen slide that is improperly flipped based on reflection of incident light;

FIG. 12B is a top view of the slide arranged as shown in FIG. 12A;

FIG. 13A illustrates the system shown in FIG. 9A configured to determine whether the specimen slide shown in FIGS. 7A-B that is improperly flipped based on reflection of incident light;

FIG. 13B is a top view of the slide arranged as shown in FIG. 13A;

FIG. 14A illustrates a system constructed in accordance with another embodiment in which a light source is positioned directly above a specimen slide;

FIG. 14B is a top view of the slide arranged as shown in FIG. 14A;

FIG. 15 illustrates a system constructed in accordance with another embodiment and configured to determine whether a filter cylinder is properly oriented based on absorption of incident light;

FIG. 16 illustrates the system shown in FIG. 15 configured to detect a filter cylinder that is improperly rotated based on reflection of incident light;

FIG. 17 illustrates a system constructed in accordance with another embodiment configured to determine whether a filter cylinder is properly facing an upward direction based on reflection of incident light;

FIG. 18 illustrates the system shown in FIG. 17 configured to detect a filter cylinder that is improperly flipped based on reflection of incident light;

FIG. 19A illustrates a system constructed in accordance with another embodiment configured to determine whether a specimen slide is properly oriented based on the ability to read a reference mark or identifier on the slide;

FIG. 19B illustrates a top view of the slide as arranged as shown in FIG. 19A;

FIG. 20A illustrates a system constructed in accordance with another embodiment configured to detect a specimen slide that is improperly oriented based on the inability to read a reference mark or identifier on the slide;

FIG. 20B illustrates a top view of the slide as arranged as shown in FIG. 20A;

FIG. 21A illustrates a specimen slide having a barcode that may be used with system embodiments shown in FIGS. 19A and 20A;

FIG. 21B illustrates a specimen slide having a two-dimensional data matrix that may be used with system embodiments shown in FIGS. 19A and 20A;

FIG. 22A illustrates a system constructed in accordance with another embodiment configured to determine whether a filter cylinder is properly oriented based on a pre-determined sequence of data read from an identifier on the cylinder; and

FIG. 22B illustrates the system shown in FIG. 22A configured to detect a filter cylinder that is improperly oriented based on reading a sequence of data that differs from the pre-determined sequence.

### DETAILED DESCRIPTION OF ILLUSTRATED EMBODIMENTS

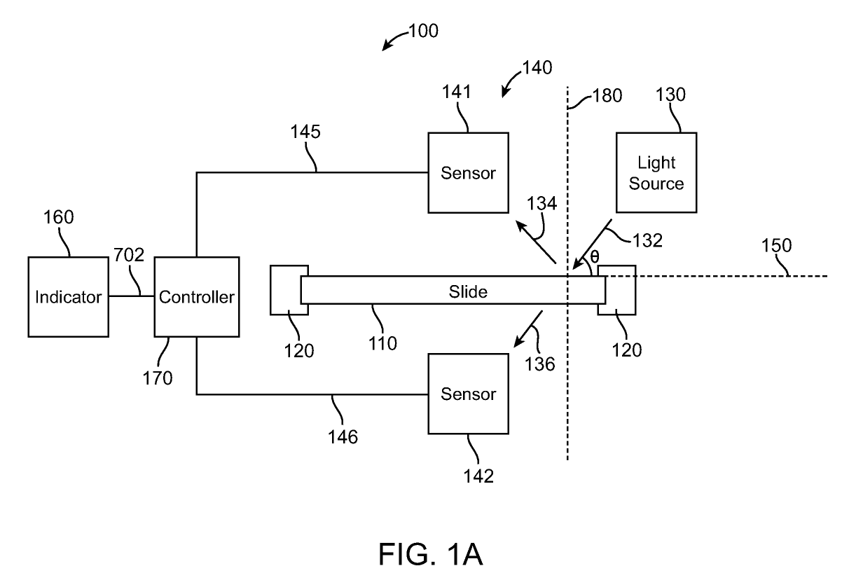

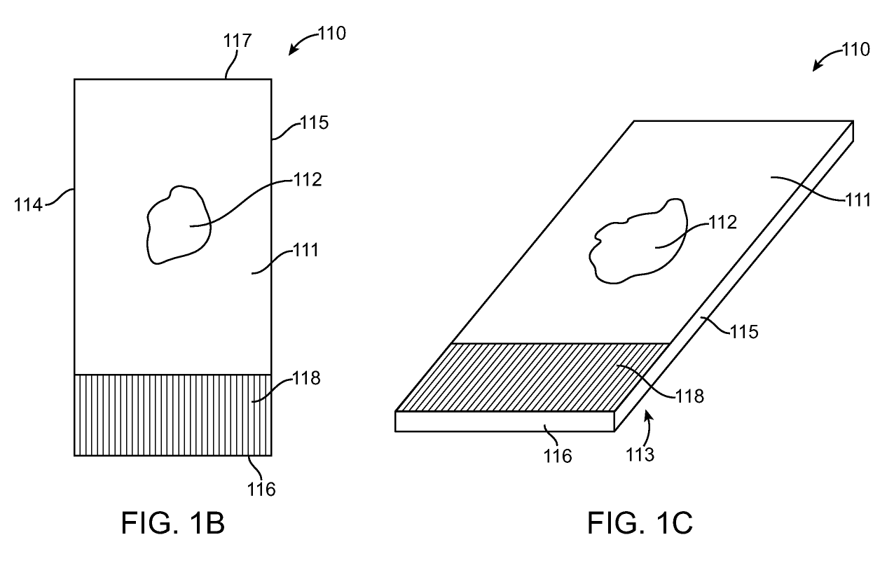

Referring to FIG. 1A, a system 100 constructed according to one embodiment is configured to determine or verify whether a biological specimen carrier, such as a slide 110 (generally referred to as slide 110), is arranged in its proper orientation. In the illustrated embodiment, the system 100 is used to confirm whether a slide 110 that is held or supported by a robotic arm or other suitable actuator or device 120 (generally illustrated in FIG. 1A) is arranged in its proper orientation. Embodiments may also be applied to detect orientations of specimen slides 110 held or supported by various other components and devices and in different environments and settings. A support device or member 120 in the form of a robotic arm is provided as one example of how embodiments may be implemented.

FIGS. 1B-1C generally illustrate a slide 110 that may be used with system 100 embodiments. The slide 110 includes a top surface 111 upon which a test sample or biological specimen 112 is placed, a bottom surface 113, a first side 114, a second or opposite side 115, a first edge 116, a second or opposite edge 117 and an absorptive element 118 associated with the slide 110, e.g., on or in the slide 110. The slide 110 may be a rectangular-shaped slide (as shown in FIGS. 1B-C) having first and second sides 114 and 115 that are longer than the first and second edges 116 and 117. Embodiments, however, may be used with specimen slides 110 having different shapes and sizes.

Further, biological specimen 112 may be a human cytological specimen that is analyzed to identify cancerous or pre-cancerous conditions or other medical conditions, and may also be an animal specimen that is analyzed by a veterinarian. For ease in illustration, the embodiments are described with reference to cytological (e.g., PAP smear) and other cancer-related specimens 112 of human patients on a slide 110. It should be appreciated, however, that embodiments are not so limited and may be utilized with the collection and analysis of various other specimens 112 and biological specimen carriers including specimen slides 110.

The orientation verification system 100 includes a light source 130 and at least one sensor or detector 140 (generally “sensor”). In the embodiment illustrated in FIG. 1A, the system 100 includes two sensors 141 and 142. The light source 130 is positioned or arranged such that light 132 emitted by the light source 130 is incident on a surface of the slide 110 at an acute angle of incidence (θ) relative to a horizontal 150, e.g., defined by the surface of the slide 110. During use, light 132 may be incident on different surfaces, e.g., surface 111 or surface 113, as embodiments are directed to determining whether a specimen slide is properly oriented. For ease of explanation, reference is made generally to surface 111.

The first sensor 141 is positioned to detect light that is reflected 134 from the surface 111 of the slide 110 at an acute angle of reflection relative to the horizontal 150. The second sensor 142 is positioned to detect light that is transmitted 136 through the slide 110, e.g., at an acute exit angle relative to the horizontal 150. Determinations regarding whether a slide 110 is properly oriented are based on one or both of the sensors 141 and 142 detecting light (or detecting a sufficient quantity of light) since a slide 110 is properly oriented if the absorptive element 118 absorbs all incident light 132 or a substantial amount of incident light 132.

For use with embodiments, the slide 110 is made of a material, such as glass, that can reflect and/or transmit light. In contrast, the absorptive element 118 associated with the slide 110, e.g., on a top surface 111 of the slide 110, absorbs all or a substantial amount of incident light 132.

According to one embodiment, the absorptive element 118 is a frosted section of a slide 110. A frosted section is typically formed within or an integral part of the slide 110 and is often used as a writing surface. For example, it is known to write numbers and/or letters on the frosted section of a slide 110 using a pencil, a pen, a marker or other suitable writing, printing or marking instrument or device. It is also known to handle the slide 110 by grasping the frosted section so as to not touch the biological specimen 112. System and method embodiments advantageously utilize an absorptive element 118, such a frosted section, in a unique way as part of an optical system 100 configured to detect whether a slide 110 is arranged in its proper orientation.

In other embodiments, the absorptive element 118 is an optically absorptive element other than a frosted section. For example, the absorptive element 118 may be an optically absorptive label or other component that is attached or adhered to a surface 111 of the slide 110. For ease of explanation, reference is made to a frosted section as an absorptive element 118. Further, although FIGS. 1B and 1C illustrate an absorptive element 118 at or adjacent to one end of the slide 110, but the absorptive element 118 may be applied to different locations on the slide 110 and may have various shapes and sizes.

In the embodiment illustrated in FIG. 1A, the light source 130 and at least one sensor are displaced or offset from a normal or other reference line or plane 180 (illustrated relative to a horizontal 150). During use, and with the system 100 including two sensors 141 and 142, incident light 132 is emitted by the light source 130, and the sensor 141 generates data or a signal 145 that can be used to provide an indication whether the sensor 141 has detected reflected light 134. Similarly, the sensor 142 generates data or a signal 146 that may be used to provide an indication whether the sensor 142 has detected transmitted light 136.

One or both of these signals 145 and 146 may be used to indicate whether the slide 110 is arranged in its proper orientation. For example, a sensor generating an output, or the data or value of the sensor output, may serve to indicate that a slide 110 is not properly oriented. As a further example, one or both of the sensor outputs 145 and 146 may indicate proper or improper slide 110 orientation by driving an indicator device 160 directly or indirectly. Further, one or both of the sensor outputs 145 and 146 can be provided to a controller 170 (as shown in FIG. 1A), such as a micro-processor, micro-controller, or logic circuitry or gates (generally referred to as “controller” 170). The controller 170 may provide the necessary data or a drive signal 172 to activate one or more indicators 160 to provide a pass/fail or proper orientation/improper orientation indication.

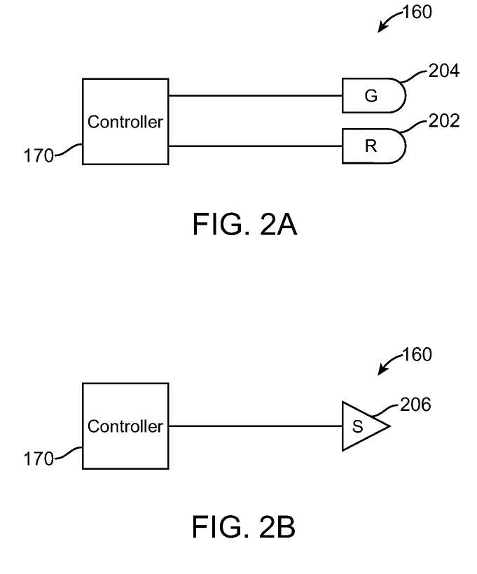

Referring to FIG. 2A, according to one embodiment, the indicator device 160 is a light or other visible indicator, such as a Light Emitting Diode (LED) or other optical indicator. Referring to FIG. 2B, the indicator 160 can also be an audible indicator or speaker 206. Embodiments can also utilize a combination of visual and audible indicators. For ease of explanation, reference is made to a LED indicator.

If a sensor detects light, which indicates that a slide 110 is not properly oriented, then a LED, e.g., a red LED 202 as shown in FIG. 2A, may be activated to indicate that processing should cease and maintenance should be performed to correct the orientation of the slide 110, whereas if a sensor does not detect light, which indicates that a slide 110 is properly oriented, then a LED, such as a green LED 204, may be activated to indicate that the slide 110 is properly oriented and that processing may proceed. It should be understood that other color systems, information and indicator configurations may be utilized. For ease of explanation, reference is generally made to an output of a sensor being provided to a controller 170, which drives an indicator 160 to indicate whether or not a slide 110 is properly oriented.

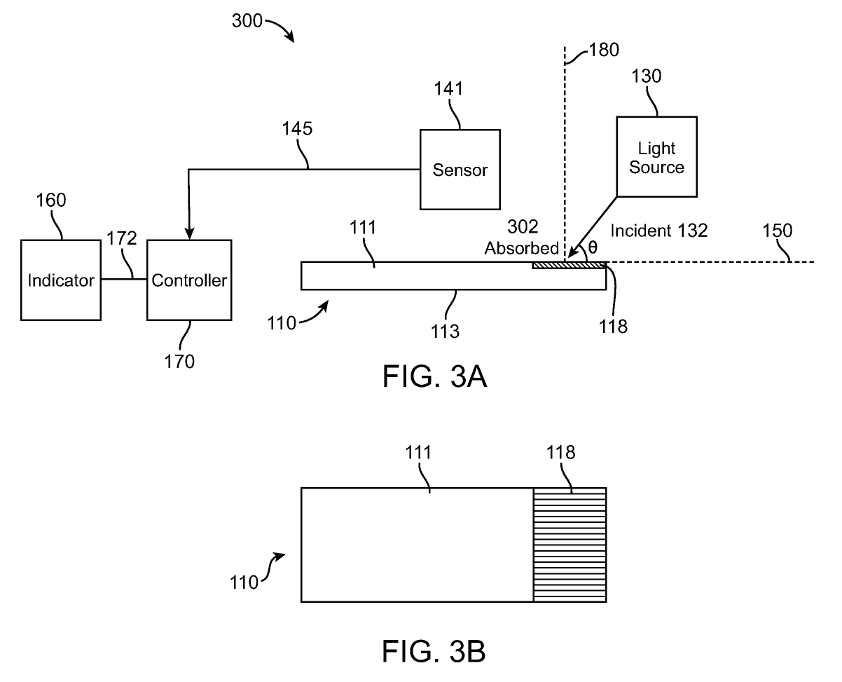

Additionally, or alternatively, referring to FIG. 3A, the controller 170 may be used to initiate other actions or displays. For example, the controller 170 may generate a signal or data that is used by a control system or computer which, in response to the signal or data, generates an error message that is displayed on a screen. Alternatively, the computer can initiate corrective action, if the system is so configured. Thus, embodiments can be configured such that one or more signals provide an indication to a user and/or one or more signals are intended to provide an indication to another system component. FIGS. 3A-14B illustrates how various embodiments that utilized some or all of the components shown in FIG. 1A may be implemented.

Referring to FIGS. 3A-B, an orientation verification system 300 constructed according to one embodiment includes a single sensor 141 and is configured for use with a slide 110, e.g., as shown in FIGS. 1B-C, that is held by a robotic arm or actuator 120 (omitted from FIG. 3A for clarity). The system 300 is configured to determine whether a slide 110 is arranged in its proper orientation based on whether an absorptive element 118 of a slide 110 is positioned within the path of incident light 132 and absorbs or substantially absorbs 302 the incident light 132.

In the embodiment illustrated in FIG. 3A, the light source 130 and the sensor 141 are on the same side of the slide 110, e.g., above the slide 110 on different sides of a normal reference line or plane 180, and the absorptive element 118 is at or adjacent to an end of the slide specimen 110. The light source 130 and the sensor 141 are positioned or arranged such that light 132 emitted by the light source 130 is incident upon a surface of the slide 110. When the slide 110 is properly oriented, light 132 is incident upon the absorptive element 118, e.g., at an acute angle of incidence (θ) relative to the horizontal 150. According to one embodiment, the angle of incidence (θ) is about 30-60 degrees, e.g., about 45 degrees. With the slide 110 arranged in its proper orientation as shown in FIG. 3A, incident light 132 is substantially or completely absorbed 302 by the absorptive element 118, and no light 132, or insufficient light, is reflected by the top surface 111 of the slide 110, and the sensor 141 does not detect any reflected light 132, or does not detect sufficient reflected light 132, to activate the sensor 141. In this case, the output 145 of the sensor 141 (or lack thereof) indicates that the slide 110 is arranged in its proper orientation.

Embodiments can be implemented using various angles of incidence (θ), e.g., from almost zero degrees to almost 90 degrees. Different angles of incidence (θ) and sensors 141 having different sensitivities may be utilized depending on system 300 parameters such as the wavelength of incident light 132, the intensity of incident light 132, the type of material forming the slide 110, whether the slide 110 material was doped to alter reflection/transmission characteristics, and the thickness of the slide 110. For example, in one embodiment, the slide 110 is a known glass microscope slide available from Erie Scientific Company, 20 Post Road, Portmouth, N.H. 03801. One suitable slide 110 is made of a material and having a thickness such that about 15% of incident light 132 at a wavelength of about 315 nm is transmitted through the glass material, and the remaining 85% of the incident light 132 is reflected or absorbed by the glass material, whereas at visible wavelengths of about 380-790 nm, about 90% of the light 132 is transmitted through the glass material.

A system 300 utilizing such a slide 110 may be implemented using a light source 130 that emits visible “red” light and is configured such that light 132 is incident upon the absorptive element 118 at an angle of incidence (θ) of about 30-60 degrees, and the reflection/transmission ratio of light reflected by the slide 110/absorptive material 118 and transmitted through the slide 110/absorptive material 118 is about 50/50. It should be understood, however, that other angles of incidence (θ) may be utilized as necessary and depending on the type and configuration of other system 300 components.

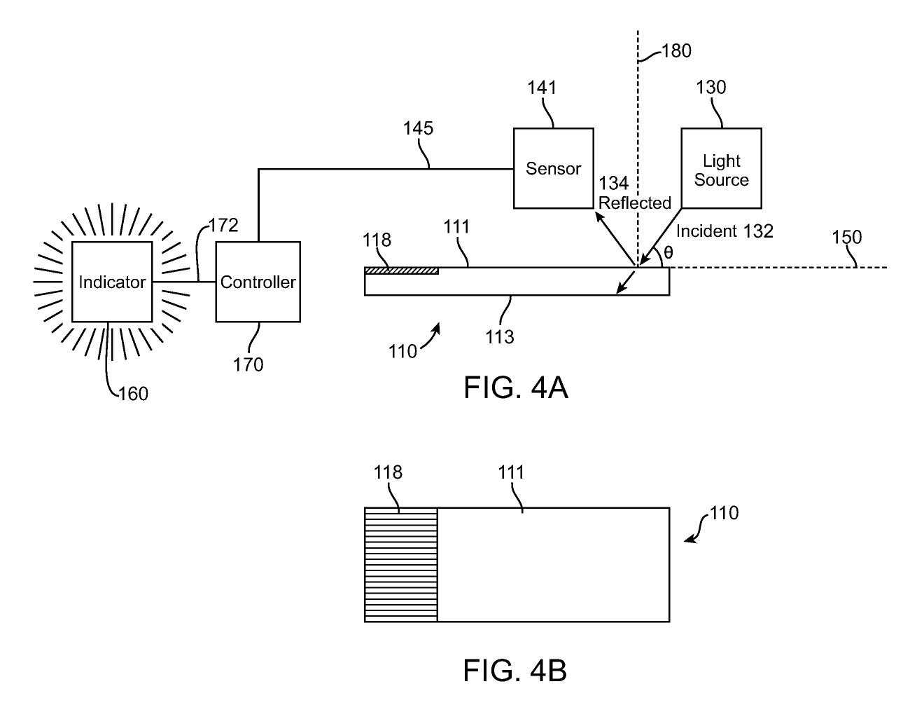

Referring to FIGS. 4A and 4B, if the slide 110 held by robotic arm or actuator 120 (not shown) is not properly oriented as a result of being rotated (relative to the example of a properly oriented slide 110 in FIG. 3A), then the absorptive element 118 is no longer within the optical path of incident light 132 emitted by the light source 130. Instead, light 132 is incident upon the top surface 111 (but not the absorptive element 118) of the slide 110 at an angle of incidence (θ) and reflected 134 and detected by the sensor 141. Upon detection of sufficient reflected light 134, the sensor 141 generates an output 145 that is provided to the controller 170, e.g., to drive the indicator 160 to signal to a user and/or other system component that the slide 110 is not arranged in its proper orientation. Incident light 132 may also be transmitted through the slide 110, but in this embodiment, slide 110 orientation may be detected based on reflected light 134 and a single sensor 141.

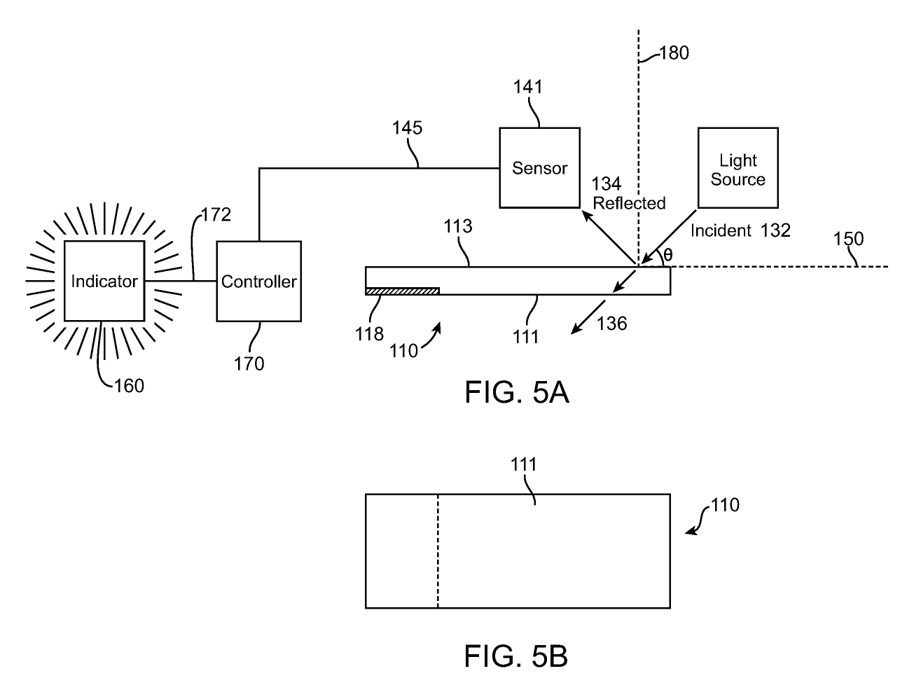

Referring to FIGS. 5A and 5B, if the slide 110 held by robotic arm or actuator 120 is not properly oriented as a result of being rotated and flipped (relative to the proper orientation shown in FIG. 3A), the absorptive element 118 is not in the optical path of incident light 132 emitted by the light source 130. In this case, light incident 132 on the bottom surface 113 of the slide 110, e.g., at an acute angle of incidence (θ), is reflected 134 and detected by the sensor 141, the output 145 of which is provided to the controller 170. The controller 170 may drive the indicator 160 to signal to a user and/or other system component that the slide 110 is not properly oriented. Incident light 132 may also be transmitted through the slide 110, but in this embodiment, slide 110 orientation is detected based on reflected light 134 and a single sensor 141.

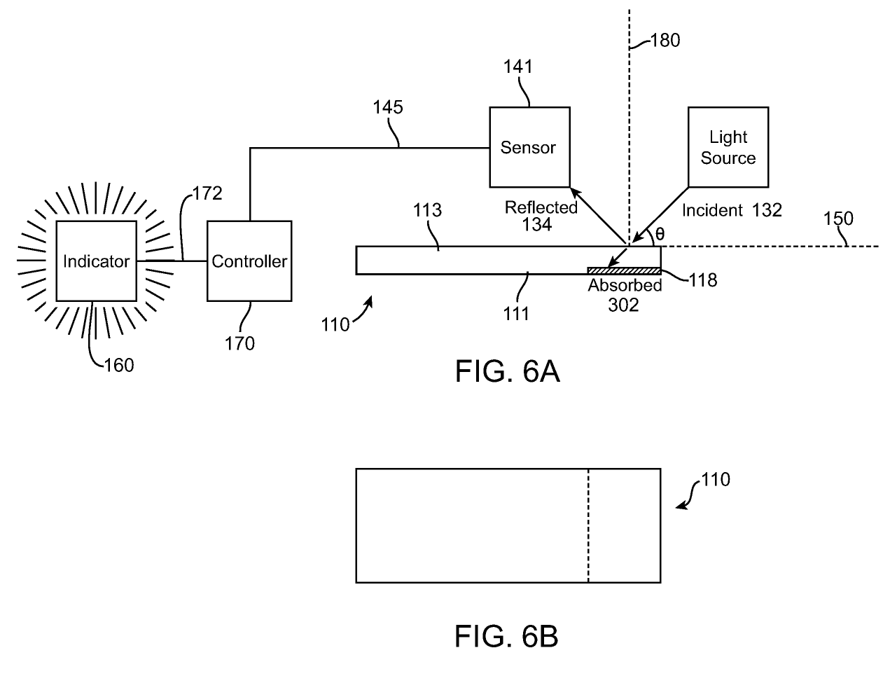

Referring to FIGS. 6A and 6B, if the slide 110 held by robotic arm or actuator 120 is not properly oriented as a result of being flipped (but not rotated relative to its proper orientation shown in FIG. 3A), then the absorptive element 118 is within the optical path of incident light 132 emitted by the light source 130. However, light incident 132 on the bottom surface 113 of the slide 110, e.g., at an acute angle of incidence (θ), is initially reflected 134 and detected by the sensor 141, and incident light 132 that is transmitted 136 through the slide 110 is absorbed 302 by the absorptive element 118. Thus, although some incident light 132 is absorbed 302 by the absorptive element 118, incident light 132 is also reflected 134 and detected by the sensor 141, the output 145 of which indicates that the slide 110 is not properly oriented.

Thus, in the system 300 embodiment illustrated in FIGS. 2A-6B, a slide 110 is arranged in its proper orientation when the optically absorptive element absorbs all or a substantial quantity of incident light 132 such that the sensor 141 does not detect any reflected light 134 or detects an insufficient quantity of reflected light 134. In contrast, a slide 110 is not in its proper orientation when sufficient incident light 132 is reflected 134 and detected by the sensor 141. Other system embodiments may operate in different manners with different slide 110 configurations and system components.

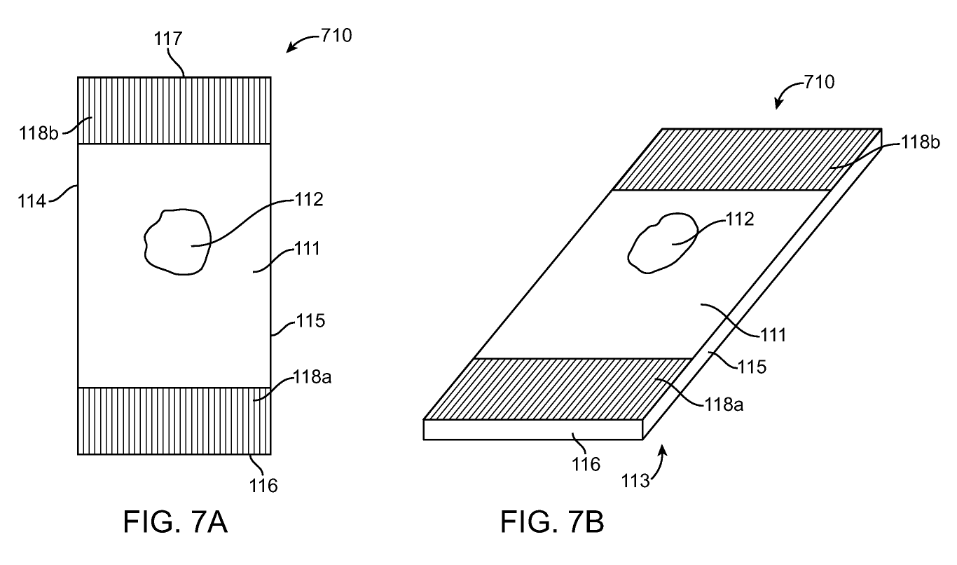

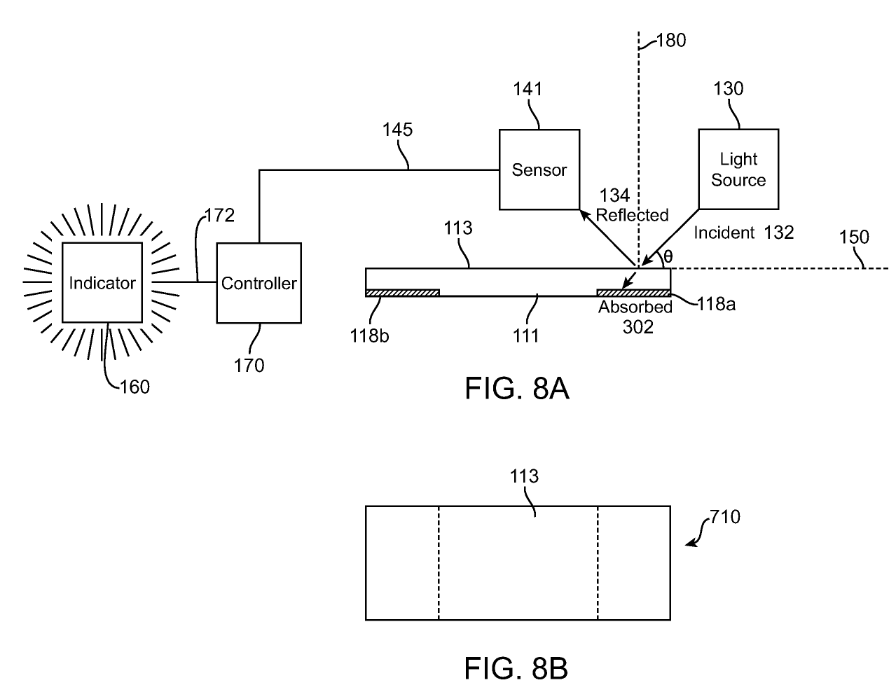

For example, referring to FIGS. 7A-B and FIGS. 8A-B, the system 300 embodiment shown in FIG. 3A may be applied to specimen slides 110 having other configurations including the slide 710 shown in FIGS. 7A-B. In the illustrated example, the slide 110 includes multiple absorptive elements 118a and 118b (generally absorptive elements 118). Referring to FIGS. 8A and 8B, the system 300 can be used to indicate whether the slide 710 is flipped (as shown in FIG. 8A). In this case, incident light 132 emitted by the light source 130 is transmitted through the bottom surface 113 of the slide 710 and absorbed by one of the absorptive elements 118, but light 132 is also reflected 134 and detected by the sensor 141. The output 145 of the sensor 141 indicates that the slide 110 is not arranged in its proper orientation.

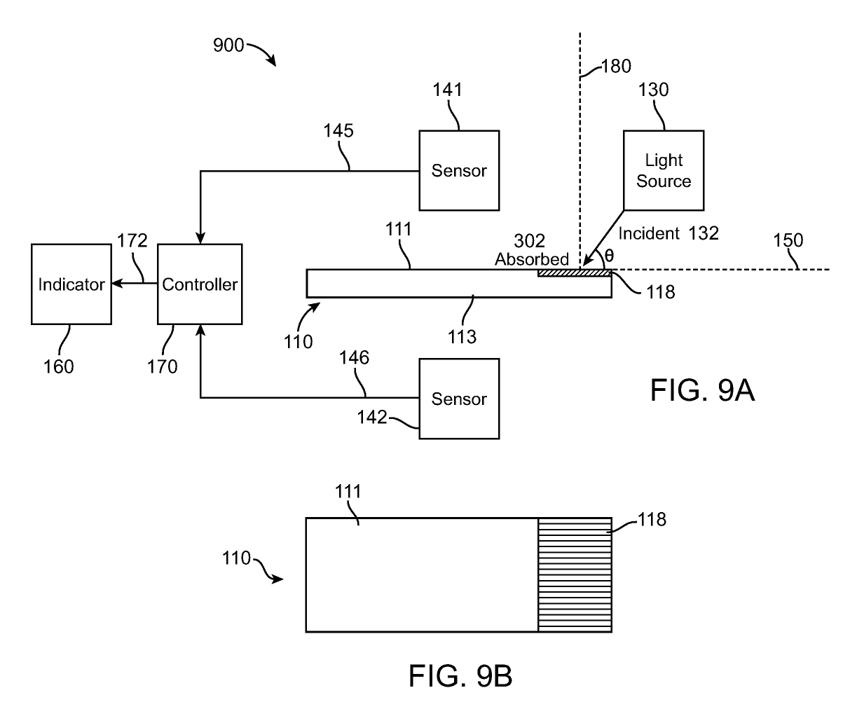

FIGS. 3A-8B illustrate system embodiments including a single sensor 141 positioned on the same side of a slide 110 as the light source 130 and configured to determine whether the slide 110 having one or multiple absorptive elements 118 is arranged in its proper orientation. Alternative embodiments can utilize other numbers and configurations of system components. According to another embodiment, as shown in FIGS. 9A-14B, two sensors, one sensor on each side of a slide 110, can be utilized to detect incident light that is reflected and/or transmitted through a slide 110 to determine whether the slide is properly oriented.

Referring to FIGS. 9A-B, a system 900 constructed according to another embodiment includes the system components shown in FIGS. 3A-6B and an additional sensor 142. The second sensor 142 is positioned on an opposite side of the slide 110 relative to the first sensor 141, and is positioned to detect incident light 132 transmitted through the slide 110. In the illustrated embodiment, the first sensor 141 and the light source 130 are positioned above the slide 110 (above the horizontal 150), and the second sensor 142 is positioned below the slide 110 (below the horizontal 150). As discussed above, for ease of explanation, the slide 110 that is held by a robotic arm or actuator 120 (not shown for clarity) is considered to be properly oriented when an absorptive element 118 at an end of a slide 110 is positioned in the path of incident light 132 and absorbs or substantially absorbs 302 the incident light 132.

More particularly, with the system 900 configured as shown in FIGS. 9A and 9B, the light source 130 and the first sensor 141 are positioned so that light 132 emitted by the light source 130 is incident on the absorptive element 118 at an acute angle of incidence (θ) relative to a horizontal 150. All or a substantial quantity of the incident light 132 is absorbed 302 by the absorptive element 118. As a result, no light 132, or insufficient light 132, reflected by or transmitted through the slide 110. As such, the sensor 141 does not detect reflected light (or does not detect sufficient reflected light), and the sensor 142 does not detect transmitted light (or does not detect sufficient transmitted light). In this case, the sensor outputs 145 and 146 (or lack of outputs) indicate that the slide 110 is properly oriented (as shown in FIG. 9A).

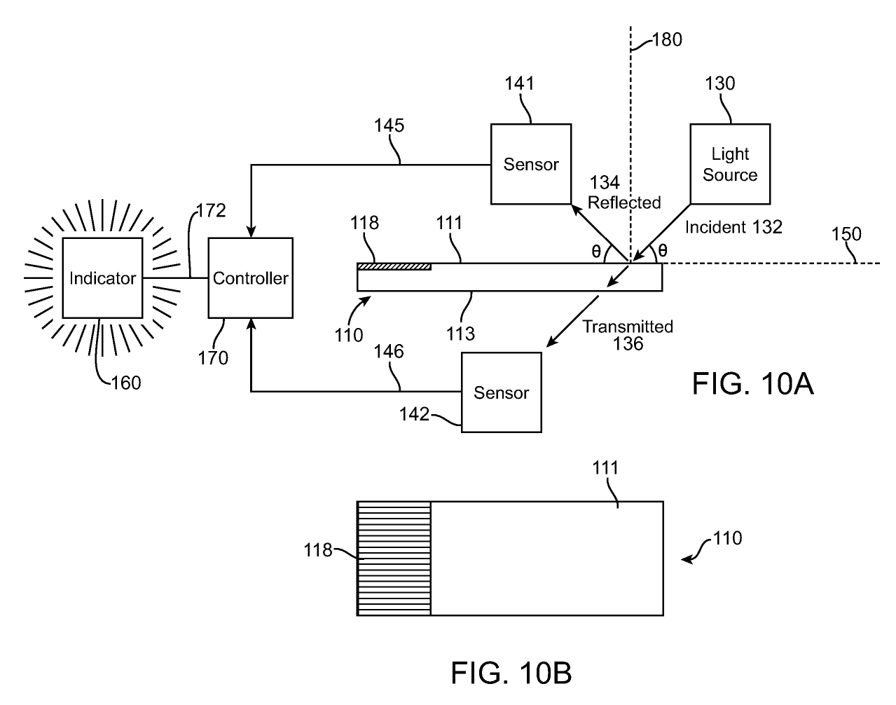

Referring to FIGS. 10A and 10B, the slide 110 held by robotic arm or actuator 120 may not properly oriented as a result of being rotated (relative to the proper orientation shown in FIG. 9A). Thus, the absorptive element 118 is no longer with in the optical path of light 132 emitted by the light source 130. Instead, light 132 that is incident on the top surface 111 of the slide 110, e.g., at an acute angle of incidence (θ) relative to the horizontal 150, is reflected 134 and detected by the sensor 141. Incident light 132 is also transmitted 136 through the slide 110 and detected by the sensor 142. The sensors 141 and 142 generate respective outputs 145 and 146 that are provided to the controller 170, which drives an indicator 160 (such as a LED or speaker) to indicate that the slide 110 is not arranged in its proper orientation.

As discussed above with reference to FIG. 3A, the angle of incidence (θ) may be about 30-60 degrees, e.g., about 45 degrees, relative to a horizontal 150, and may vary as necessary or with different system component arrangements. Further, the sensitivities of sensors 141 and 142 may differ or be about the same depending on reflection and transmission characteristics. For example, in systems in which more incident light 132 is reflected 134 than transmitted 136, the sensitivities of the sensors 141 and 142 can both be sufficiently high to detect reflected 134 and transmitted 136 light. In an alternative embodiment, the sensor 142 may be more sensitive than the sensor 141 since the sensor 142 must detect smaller quantities of transmitted 136 light. Similarly, in systems in which more light 132 is transmitted 136, the sensitivities of the sensors 141 and 142 can both be sufficiently high to detect reflected 134 and transmitted 136 light. In an alternative embodiment, the sensor 142 may be less sensitive than the sensor 141 since the sensor 141 must detect smaller quantities of reflected 134 light.

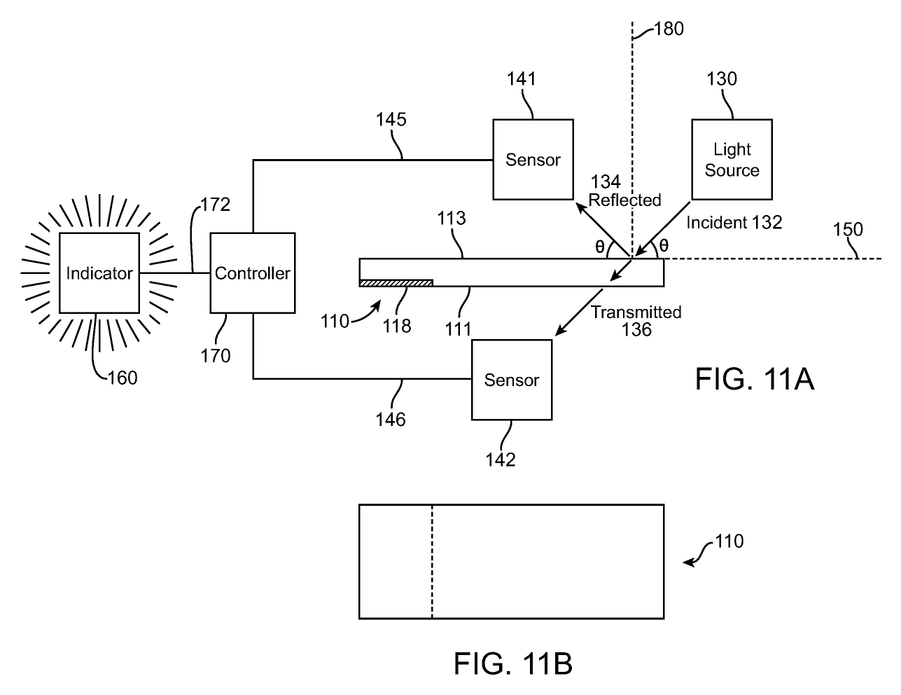

Referring to FIGS. 11A and 11B, if the slide 110 held by robotic arm or actuator 120 is not properly oriented (relative to the proper orientation shown in FIG. 9A) as a result of being rotated and flipped, then the absorptive element 118 is not in the optical path of light 132 emitted by the light source 130. As a result, light 132 that is incident upon the bottom surface 113 of the slide 110, e.g., at an acute angle of incidence (θ), is reflected 134 and detected by the sensor 141, and also transmitted 136 through the slide 110 and detected by sensor 142. Upon detecting sufficient quantities of light, the sensors 141 and 142 generate respective outputs 145 and 146 that are provided to the controller 170, which drives an indicator 160 to signal to a user or other system component that the slide 110 is not arranged in its proper orientation.

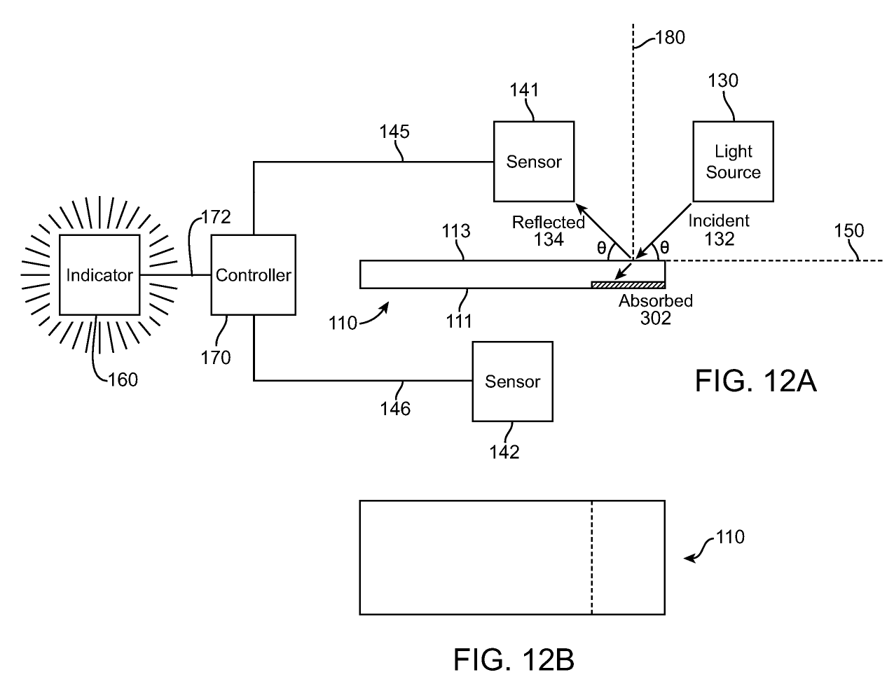

Referring to FIGS. 12A and 12B, if the slide 110 held by robotic arm or actuator 120 is not properly oriented (relative to the proper orientation shown in FIG. 9A) as a result of being flipped, the absorptive element 118 is within the optical path of light 132 emitted by the light source 130. However, light 132 that is incident at an acute angle of incidence (θ) is initially reflected 134 and detected by the sensor 141, and light 132 that is transmitted 136 through a portion of the slide 110 is absorbed 302 by the underlying absorptive element 118. Thus, the sensor 141 detects reflected light 134, but the sensor 142 does not detect transmitted light 136. In this case, the sensor 141 generates an output 145 that indicates that the slide 110 is not arranged in its proper orientation.

Thus, in the illustrated embodiment, a slide 110 is properly oriented when the optically absorptive element substantially absorbs incident light 132 such that neither sensor 141 nor sensor 142 detects light or detects insufficient light, but is oriented improperly when sufficient incident light 132 is reflected 134 and/or transmitted 136 and detected by one or both of the sensors 141 and 142. The system 900 having two sensors 141 and 142 may also be applied to specimen slides 110 of other configurations including the slide 710 shown in FIGS. 7A-B, which includes an absorptive element 118 at each end of the slide 710.

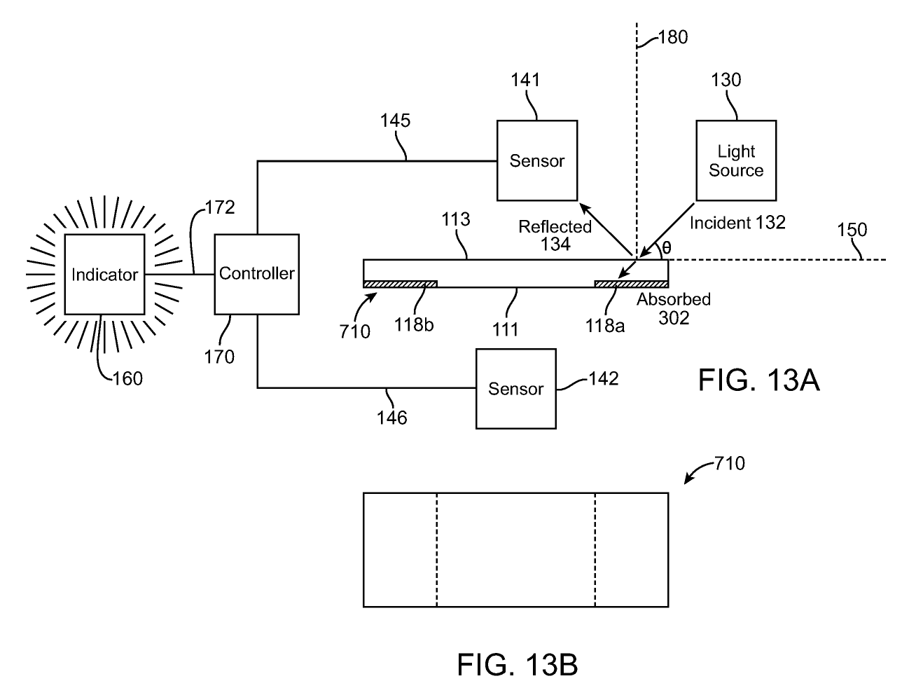

For example, as shown in FIGS. 13A and 13B, a system 900 including two sensors 141 and 142 may be used to indicate whether the slide 710 is properly oriented or whether the slide 710 is improperly flipped (as shown in FIG. 13A). In this case, one of the absorptive elements 118a is within the optical path of light 132 emitted by the light source 130, but the light 132 is initially reflected 134 and detected by the sensor 141, which indicates that the slide 110 is not properly oriented.

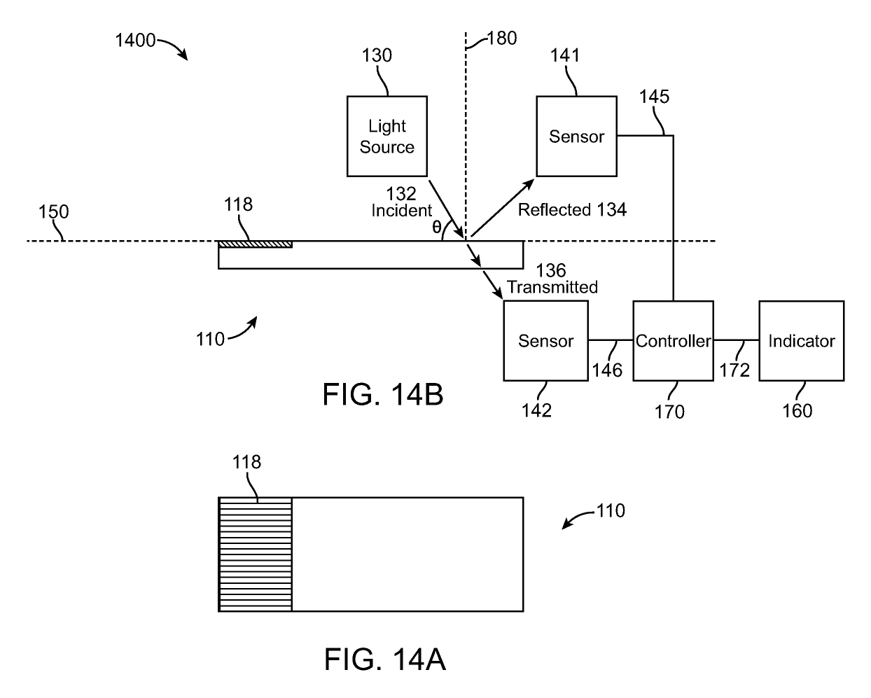

It should also be understood that system configurations other than the systems 100, 300 and 900 described above can be utilized to determine whether a slide 110 is arranged in its proper orientation using an offset or angled arrangement of a light source 130 and one or more sensors, and based on whether light is absorbed 302, or reflected 134 and/or transmitted 136. For example, as shown in FIGS. 14A and 14B, a system 1400 constructed according to another embodiment includes a light source 130 positioned directly above a slide 110, a sensor 141 that is positioned above the slide 110, but not directly above a slide 110, and another sensor 142 that is positioned below the slide 110, but not directly below a slide 110. Thus, system components may be positioned directly above a slide 110 or above and offset relative to the slide 110.

Moreover, other system configurations can be used with additional optical components, e.g., mirrors that reflect light 132 to sensors at different locations. Thus, the particular optical system components and angular arrangements employed may depend, for example, on the length of the slide 110, the number of sensors, the incidence, reflection and exit angles, the sizes or lengths of the absorptive elements 118 and/or the size of the biological specimen 112. Thus, FIGS. 1A-14B are provided to illustrate examples of how embodiments may be implemented using one and multiple sensors.

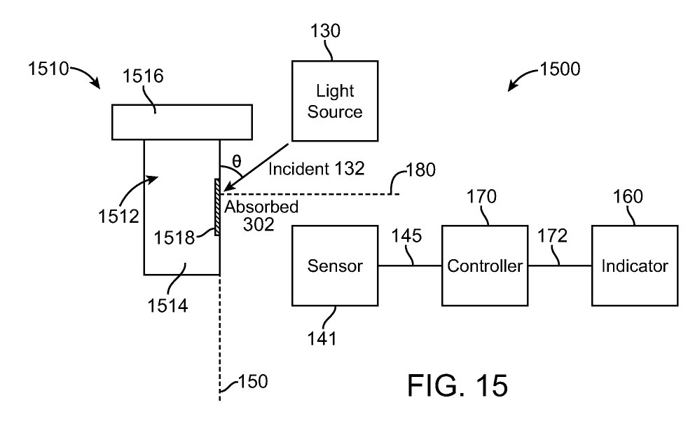

Embodiments can also be applied to determine whether other biological specimen carriers, such as a filter cylinder for collecting cells of a biological specimen, are properly oriented. For example, referring to FIG. 15, a system 1500 according to another embodiment can be used to determine whether a filter cylinder 1510 is properly aligned or in its proper orientation. In the illustrated embodiment, the filter cylinder 1510 includes a cylindrical body 1512 having an outer surface 1514, a cap 1516 and an absorptive element 118, such as an optically absorptive label or other suitable absorptive element or material 118. The cap 1516 is normally held or supported by a robotic arm or other actuator or device 120 (not shown).

In the illustrated embodiment, the system 1500 includes a light source 130, a sensor 140, a controller 170 and an indicator 160 as discussed above. The light source 130 is configured to emit light 132 at an acute angle of incidence (θ) relative to the outer surface 1514 of the cylinder 1510. A sensor 141 is positioned to detect light reflected by the outer surface 1514. Determinations regarding whether a filter cylinder 1510 is arranged in its proper orientation are based on whether light 132 is absorbed 302 by the absorptive element 118, or reflected by the outer surface 1514 and detected by the sensor 141.

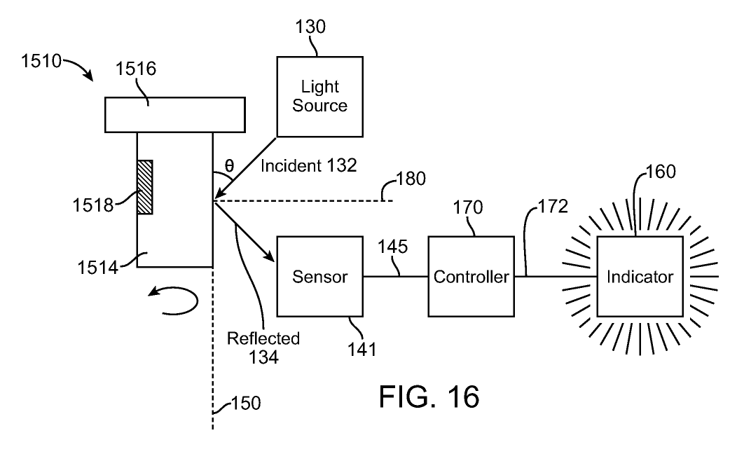

More particularly, in the illustrated embodiment, the proper orientation of a filter cylinder 1510 may involve the cylindrical body 1512 being rotated to such that a mark or code (not shown) is positioned at a particular location to allow a reader or scanner to read the code. Thus, in the illustrated embodiment, the proper orientation may be a rotational position such that the mark or code is on the right side of the filter cylinder 1510. However, if the filter cylinder 1510 is rotated such that the absorptive element 118 is displaced from its intended, pre-determined position (as shown in FIG. 16), light 132 that is incident on the outer surface 1514 is reflected 134 and detected by the sensor 141, the output 145 of which can be used to drive an indicator 160 such as a light or speaker to indicate that the filter cylinder 1512 should be rotated to its correct position.

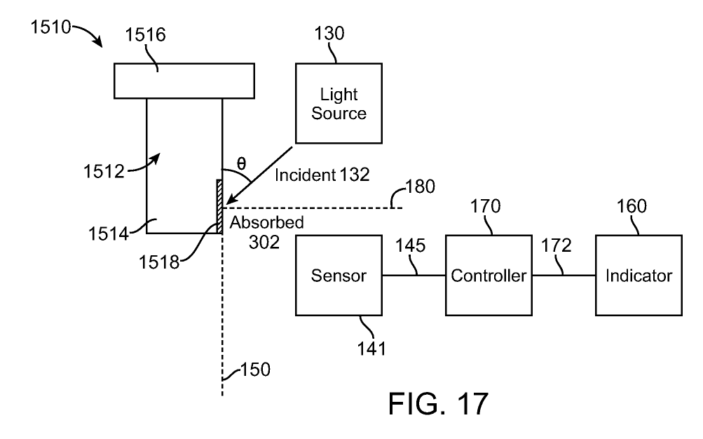

Additionally, or alternatively, embodiments can be used to determine whether a filter cylinder 1510 is flipped. For example, referring to FIG. 17, the absorptive element 118, light source 130 and sensor 141 can be configured so that when the filter cylinder 1510 is in a proper position (e.g., an upright position as shown in FIG. 17), light 132 emitted by the light source 130 is absorbed 302 by the absorptive element 118, and the sensor 141 does not detect reflected light, in which case the output 145 of the sensor 141 indicates that the filter cylinder 1510 is in its proper upright position.

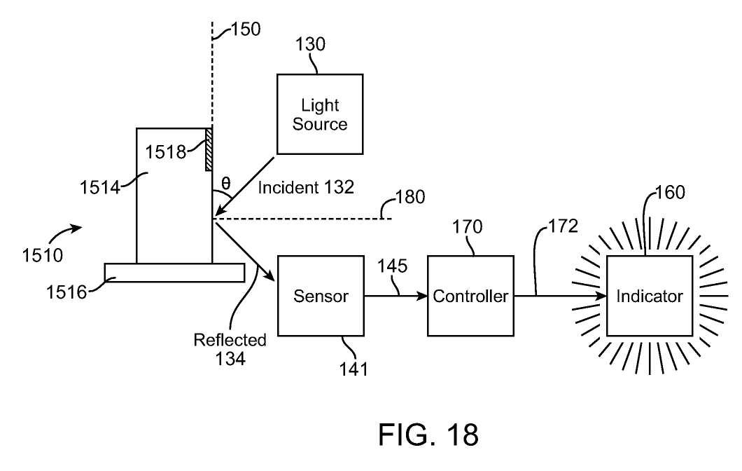

Referring to FIG. 18, if the filter cylinder 1510 is not in its proper position (e.g., flipped or upside down as shown in FIG. 18), then incident light 132 is reflected 134 and detected by the sensor 141, the output 145 of which indicates that the filter cylinder 1510 orientation is not correct.

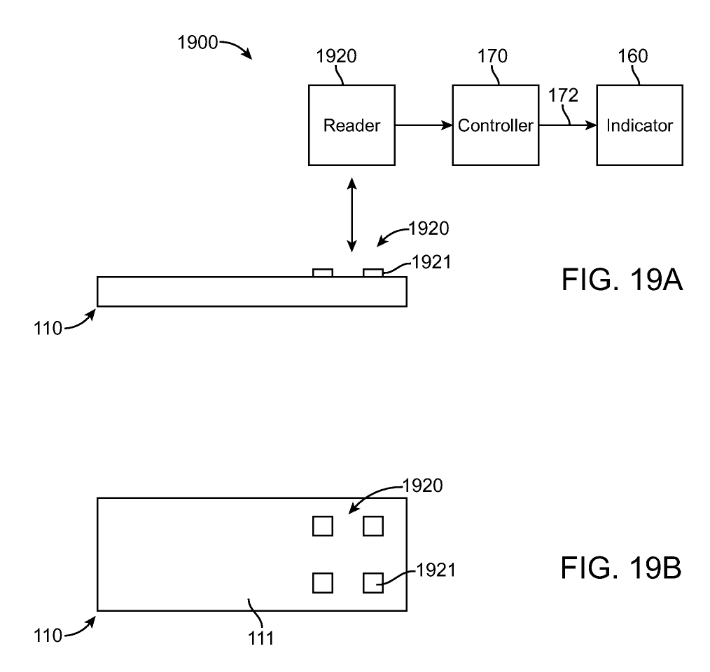

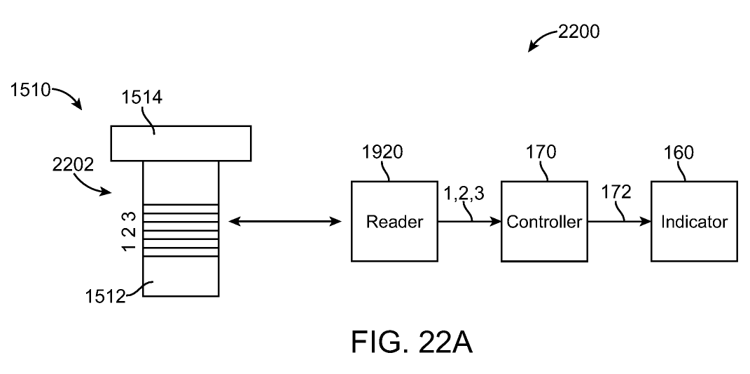

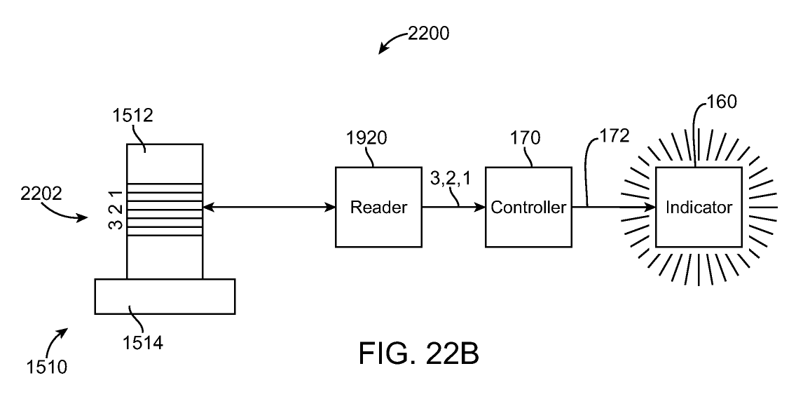

Other embodiments are directed to determining whether the orientation of a biological specimen carrier is correct based on the ability to read a mark, code or identifier (generally “identifier”) at a pre-determined location on the carrier. FIGS. 19A-21B illustrate application of embodiments to a slide 110, and FIGS. 22A and 22B illustrate application of embodiments to a filter cylinder 1510.

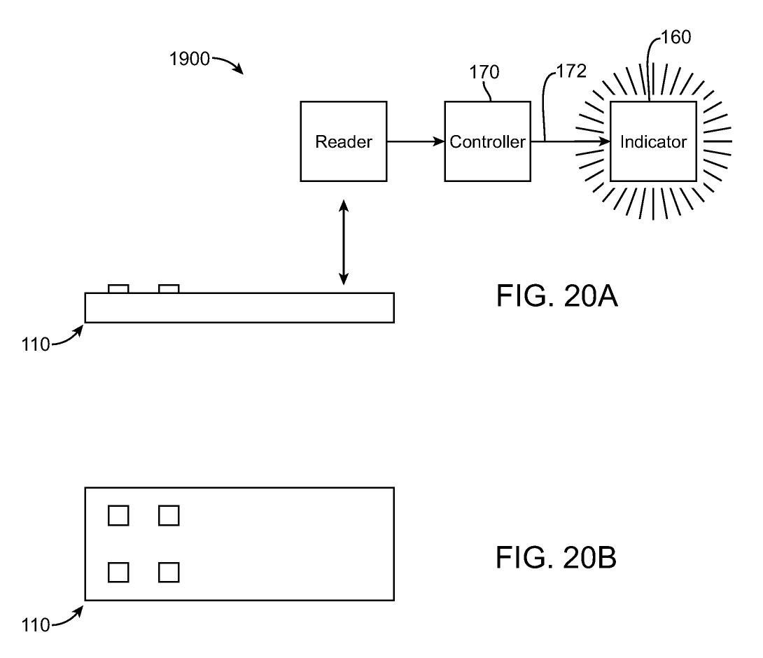

Referring to FIGS. 19A and 19B, a system 1900 constructed according to another embodiment includes a reader or scanner 1910 and an identifier 1920 that is applied to surface of a slide 110, e.g., a top surface 111 of the slide 110. The slide 110 and a reader 1920 can be arranged so that the reader 1920 can decode or read the identifier 1910 when the slide 110 is properly oriented, e.g., as shown in FIGS. 19A and 19B, in which the identifier 1910 is positioned below the reader 1920 or within the field of view of the reader 1920 and on an upper surface of the slide 110. Referring to FIGS. 20A and 20B, if the slide 110 is not properly oriented, e.g., is rotated 180 degrees, then the identifier 1920 is not positioned to allow the reader 1910 to reader the identifier 1920. In this case, a determination can be made that the slide 110 is not arranged in its proper orientation.

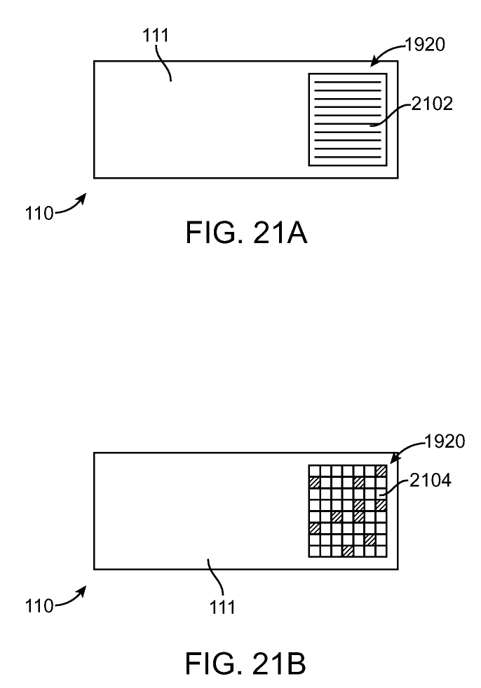

Various identifiers 1920 can be used with embodiments. In the embodiment illustrated in FIGS. 19A-20B, the identifier 1920 can include one or multiple dots or other markings 1921, and the dots or markings 1921 can, e.g., be read using optical character recognition or another suitable system. The identifier 1920 can also be a barcode 2102 or a data matrix 2104, as shown in FIGS. 21A and 21B, and the reader 1920 can be a suitable bar-code or matrix reader.

Referring to FIGS. 22A and 22B, an identifier 2202 can also be applied partially or completely around a filter cylinder 1510. The filter cylinder 1510 and the reader 1920 can be positioned or arranged so that a determination can be made whether the filter cylinder 1510 is in its proper orientation, e.g., in an upright position, when the reader 1920 reads a certain sequence of data (e.g., 1, 2, 3, 4). However, if the filter cylinder 1510 is not properly oriented, e.g. upside down, then the reader 1920 reads data in the opposite sequence (e.g., 4, 3, 2, 1). The reader 1920 provides the data to the controller 170, which can determine the sequence of data, and based on the determined sequence, generate an output 172 indicating whether the cylinder filter 1510 is in an upright position or upside down. It should be understood that various identifiers 2202 and sequences of letters, numbers and/or symbols can be used for this purpose.

Although particular embodiments have been shown and described, it should be understood that the above discussion is intended to illustrate and not limit the scope of these embodiments, and various changes and modifications may be made without departing from scope of embodiments. For example, although system and method embodiments are described with reference to a slide 110 that is considered to have a proper orientation when the top surface of the slide includes a specimen and the absorptive element is in a certain location, embodiments can be adapted to confirm different orientations for other applications and system configurations. Further, system and method embodiments may be implemented with different numbers of sensors, detectors, different arrangements of sensors and detectors and various absorptive elements and light sources.

What is claimed is:

1. A system for determining an orientation of a biological specimen carrier, comprising:
an optically absorptive element associated with a surface of the biological specimen carrier;
a light source arranged such that light emitted by the light source is incident on the surface of the biological specimen carrier, wherein the biological specimen carrier is properly oriented if incident light is substantially absorbed by the absorptive element; and
a sensor positioned to detect light not absorbed by the absorptive element and reflected by the surface of the biological specimen carrier.

2. The system of claim 1, wherein an output of the sensor is based on a quantity of reflected light that is detected and indicates whether the biological specimen carrier is properly oriented.

3. The system of claim 1, wherein light is incident on the surface of the biological specimen carrier at an acute angle of incidence relative to the surface of the biological specimen carrier.

4. The system of claim 1, wherein light is reflected from the surface of the biological specimen carrier at an acute angle of reflection relative to the surface of the biological specimen carrier.

5. The system of claim 1, the absorptive element being attached to the surface of the biological specimen carrier.

6. The system of claim 1, the absorptive element being formed within the biological specimen carrier.

7. The system of claim 1, the light source and the sensor being positioned on the same side of the biological specimen carrier.

8. The system of claim 1, wherein the light source is a light emitting diode.

9. The system of claim 1, wherein the biological specimen carrier is a specimen slide.

10. A system for determining an orientation of a biological specimen carrier, comprising:
an optically absorptive element associated with a surface of the biological specimen carrier;
a light source positioned on a first side of the biological specimen carrier such that light emitted by the light source is incident on the surface of the biological specimen carrier, wherein the biological specimen carrier is properly oriented if incident light is substantially absorbed by the absorptive element;
a first sensor positioned on the first side of the biological specimen carrier to detect light not absorbed by the absorptive element and reflected by the surface of the biological specimen carrier; and
a second sensor positioned on a second side of the biological specimen carrier to detect light not absorbed by the absorptive element and transmitted through the absorptive element.

11. The system of claim 10, wherein light is incident on the surface of the biological specimen carrier at an acute angle of incidence relative to the surface of the biological specimen carrier.

12. The system of claim 11, wherein the angle of incidence is about 30 degrees to about 60 degrees relative to the surface of the biological specimen carrier.

13. The system of claim 10, wherein light reflected from the surface of the biological specimen carrier is reflected at an acute angle of reflection relative to the surface of the biological specimen carrier.

14. The system of claim 10, the absorptive element being attached to the surface of the biological specimen carrier.

15. The system of claim 14, wherein the absorptive element is an optically absorptive label.

16. The system of claim 10, the absorptive element being formed within the biological specimen carrier.

17. The system of claim 16, wherein the absorptive element is a frosted section of the biological specimen carrier.

18. The system of claim 10, at least one sensor generating an output based on a quantity of light detected and that indicates whether the biological specimen carrier is properly oriented.

19. The system of claim 18, wherein the biological specimen carrier is not properly oriented when incident light is incident upon a portion of the biological specimen carrier other than the optically absorptive element.

20. The system of claim 18, wherein the biological specimen carrier is not properly oriented when a sufficient quantity of incident light is reflected and detected by the first sensor.

21. The system of claim 18, wherein the biological specimen carrier is not properly oriented when a sufficient quantity of light is transmitted through the biological specimen carrier and detected by the second sensor.

22. The system of claim 10, the light source, the first sensor and the second sensor being positioned to indicate whether the biological specimen carrier is rotated 180 degrees relative to a proper orientation of the biological specimen carrier.

23. The system of claim 10, the light source, the first sensor and the second sensor being positioned to indicate whether the biological specimen is rotated 180 degrees and upside down relative to a proper orientation of the biological specimen carrier.

24. The system of claim 10, further comprising:
a controller operably coupled to the first and second sensors; and
an indicator operably coupled to the controller, the controller being configured to drive the indicator based on whether the biological specimen carrier is properly oriented.

25. The system of claim 24, wherein the indicator is a light or a speaker.

26. The system of claim 10, wherein the optically absorptive element is markable with ink.

27. The system of claim 10, wherein the biological specimen carrier is a specimen slide.

28. A method of determining an orientation of a biological specimen carrier, comprising:
positioning a light source on a first side of the biological specimen carrier, the light source being arranged such that light emitted by the light source is incident on a surface of the biological specimen carrier, wherein the biological specimen carrier is properly oriented if the incident light is substantially absorbed by the absorptive element; and
positioning a first sensor on the first side of the specimen carrier, the first sensor being positioned to detect light not absorbed by the absorptive element and reflected by the surface of the biological specimen carrier.

29. The method of claim 28, further comprising:
activating the light source, wherein light emitted by the light source is incident on the surface of the biological specimen carrier at an acute angle of incidence relative to the surface of the biological specimen carrier; and
determining whether the biological specimen carrier is properly oriented based on a quantity of light detected by the first sensor.

30. The method of claim 29, wherein the angle of incidence is about 30 degrees to about 60 degrees relative to the surface of the biological specimen carrier.

31. The method of claim 28, further comprising:
positioning a second sensor on a second side of the biological specimen carrier, the second sensor being positioned to detect light not absorbed by and transmitted through the biological specimen carrier.

32. The method of claim 31, further comprising:
activating the light source, wherein light emitted by the light source is incident on the surface of the biological specimen carrier at an acute angle of incidence relative to the surface of the biological specimen carrier; and
determining whether the biological specimen carrier is properly oriented based on a quantity of light detected by the second sensor.

33. The method of claim 28, wherein light is incident on a frosted section of a slide.
